(19) United States
(12) Patent Application Publication
(10) Pub. No.: US 2004/0103579 A1
(43) Pub. Date: Jun. 3, 2004

(54) Generation of gaseous product for insect attraction

(76) Inventors: James A. Nolen, West Greenwich, RI (US); Albert Kwame Gowu-Mensah, Accra (GH)

Correspondence Address: George W. Rauchfuss, Jr., Ohlandt, Greeley Ruggiero & Perle, L.L.P., Tenth Floor, One Landmank Square, Stamford, CT, 06901-2682, US

(21) Appl. No.: 10/723,421

(22) Filed: Nov. 26, 2003

Related U.S. Application Data
(60) Provisional application No. 60/430,323, filed on Dec. 2, 2002.

(51) Int. Cl. A01M 1/20

(52) U.S. Cl. 43/107

(57) ABSTRACT

An improved method for providing an insect-attracting gaseous product to an insect trap is provided by using an ozone-producing unit and activated carbon so that ozone produced in the unit from air or oxygen contacts the activated carbon, producing an insect-attracting gaseous product, which insect-attracting gaseous product can be fed to an insect trap. The insect-attracting gaseous product of the invention exceeds the effectiveness of carbon dioxide alone in attracting insects. An insect trap is placed in fluid communication with the output of such a unit producing an insect-attracting gaseous product to provide an effective insect trap.

### RELATED APPLICATION

This application claims the benefit of U.S. Provisional Patent Application No. 60/430,323, filed Dec. 2, 2002.

### FIELD OF THE INVENTION

The invention relates to a method for providing an insect-attracting gaseous product for attracting insects, to apparatus for providing such insect-attracting gaseous product, and to apparatus for attracting and/or destroying insects employing such insect-attracting gaseous product. The invention further relates to a method for providing an insect-attracting gaseous product containing carbon dioxide for attracting insects, apparatus for providing an insect-attracting gaseous product containing carbon dioxide, and apparatus for attracting and/or destroying insects with such an insect-attracting gaseous product containing carbon dioxide.

### BACKGROUND OF THE INVENTION

Devices for attracting and destroying insects are well known in the art. While the prior art devices have employed a number of mechanisms and materials to attract insects, such as for example, heat, light, odor emitting substances, pheromones, kairomones and various chemicals, more recently it has been discovered that carbon dioxide alone or with other attractants such as octenol are particularly effective in attracting insects. Examples of devices employing carbon dioxide and octenol are those disclosed in U.S. Pat. Nos. 5,205,064 and 6,055,766.

Researchers in the field of entomology have discovered that biting insects such as midges, biting flies, and mosquitoes are attracted to blood hosts by the odor of kairomones, which are chemicals given off by the blood host and act as attractants to such biting insects. Such kairomones include carbon dioxide, exhaled by both avian and mammalian blood host, and octenol, an alcohol that is given off by mammalian blood hosts. Mosquitoes and biting flies can detect the odor of carbon dioxide given off by a blood host at a distance of approximately 90 meters. Biting insects locate a blood host by tracking the carbon dioxide plume created by a blood host. It has been discovered that a mixture of carbon dioxide and octenol is especially attractive to insects seeking mammalian blood hosts.

In the apparatus and devices heretofore proposed for attracting and/or destroying insects, the apparatus and devices rely upon a pressurized canister charged with propane, carbon dioxide, octenol, or both carbon dioxide and octenol, with or without other pheromones or other attractants, for supplying the attractant materials to the apparatus or device. However, there are various disadvantages associated with the use of such canisters. Among those disadvantages is the fact that the canister generally is very limited in size and needs to be constantly replaced. With the need for replacement, the apparatus and device cannot readily be placed in remote locations without the necessity for frequent trips to the location for canister monitoring and replacement. It would therefore be quite beneficial for a better source of carbon dioxide, with or without pheromones or other attractants, to be provided and for such a source be one that does not require monitoring and/or replacement due to dissipation of all or nearly all the carbon dioxide and/or pheromones or other attractants in the canister.

### SUMMARY OF THE INVENTION

It has now been discovered that an insect-attracting gaseous product for use in attracting insects to apparatus for attracting and/or destroying such insects can be provided by an ozone generator for converting atmospheric air or pure oxygen to ozone, with the ozone generator being also in communication with a source of activated carbon for treating the generated ozone to convert ozone to carbon dioxide and oxygen. It has also been discovered that such an ozone generator in communication with a source of activated carbon can provide not only a source of carbon dioxide, but can also provide an insect-attracting gaseous product that acts as an enhanced attractant for insects compared to carbon dioxide alone. The ozone generator in communication with a source of activated carbon of the present invention can be combined with any suitable insect attracting and/or destroying apparatus or device for the purpose of attracting and destroying such insects.

Various embodiments of the invention comprise the following:

(a) A process for supplying insect-attracting gaseous product to an insect trap for attracting insects, the process comprising passing air or pure oxygen through an ozone-producing unit to produce a gaseous product containing ozone passing the gaseous product containing ozone through activated carbon to produce an insect-attracting gaseous product, and providing the insect-attracting gaseous product to the insect trap. The ozone-producing unit preferably comprises a corona discharge area.

(b) A process as described above, wherein the insect-attracting gaseous product contains at least carbon dioxide.

(c) A process as described above, wherein the insect-attracting gaseous product contains at least one of nitrous oxide and an NOₓ compound, such as nitric oxide.

(d) A process as described above, wherein the insect trap to which the insect-attracting gaseous product is provided also contains a further insect attractant and elements for retaining and optionally destroying insects attracted to the trap.

(e) Apparatus for providing insect-attracting gaseous product to an insect trap comprising:

an enclosed housing having an inlet for entry of air or pure oxygen into the housing and a discharge outlet for discharge of insect-attracting gaseous product, said discharge outlet adapted to be placed in fluid communication with an insect trap for providing the insect-attracting gaseous product to said trap;

an element in said housing for treating air or pure oxygen to produce a gaseous product containing ozone;

an activated carbon element;

a fluid pathway through said housing for providing flow of air or pure oxygen to the element for producing an ozone-containing gaseous product and thereafter for said ozone-containing gaseous product to contact the activated carbon element to produce an insect-attracting gaseous product, and then for said gaseous product to be discharged through the discharge outlet.

(f) The apparatus as described above, wherein the insect-attracting gaseous product contains at least carbon dioxide.

(g) The apparatus as described above, wherein the insect-attracting gaseous product contains at least one of nitrous oxide and an NOₓ compound, such as nitric oxide.

(h) The apparatus as described above, wherein the element for producing the ozone-containing gaseous product comprises at least one pair of electrodes in said housing and connectable to a source of electrical power for providing a corona discharge area in said housing.

(i) A device and process for trapping and optionally destroying insects comprising:

an insect trap; and

an ozone producing unit provided with activated carbon for producing an insect-attracting gaseous product by contacting the activated carbon with ozone produced by the unit, said unit being in fluid communication with said insect trap for providing the insect-attracting gaseous product to the insect trap.

(j) A device and process as described above, wherein the insect-attracting gaseous product contains at least carbon dioxide.

(k) A device and process as described above, wherein the insect-attracting gaseous product contains at least one of nitrous oxide and an NOₓ compound, such as nitric oxide.

(l) A device and process as described above wherein the ozone-producing unit comprises a corona discharge area.

(m) A device and process as described above wherein the ozone-producing unit comprises:

an inlet for entry of air or pure oxygen into the unit;

a discharge outlet for discharge of the insect-attracting gaseous product from the unit to the insect trap; and

a fan for causing entry of air or pure oxygen into the unit through the inlet and discharge of the insect-attracting gaseous product through the discharge outlet.

### BRIEF DESCRIPTION OF THE DRAWINGS

The invention is illustrated, but not limited by, the embodiments shown in the accompanying drawings in which:

FIG. 1 is a side view of an insect-attracting gaseous product-producing device useful in one embodiment of the invention;

FIG. 2 is a side view of the device of FIG. 1 with the side panel of the device removed;

FIG. 3 is a cross sectional view of the device along line 3-3 of FIG. 2; and

FIG. 4 is a side view of the device of FIG. 1 attached to an insect attracting/destroying element.

### DETAILED DESCRIPTION OF THE INVENTION AND PREFERRED EMBODIMENT

The invention can employ any suitable ozone-generating device, such as those devices that produce ozone by corona wire or by UV, as the generator of insect-attracting gaseous product. The ozone generator is equipped with a source of activated carbon, such as by either placing the source of activated carbon in the ozone generator device or in fluid communication with the ozone generator such that the ozone produced by the generator is caused to flow through the activated carbon. As atmospheric air or pure oxygen is caused to flow through the ozone generator, ozone (O₃), with or without other gasses such as an oxide of nitrogen, is produced. If pure oxygen is caused to flow through the ozone generator, in general only ozone will be produced. As the ozone and other gases, if present, flow through the activated carbon, the ozone is converted into diatomic oxygen (O₂) and carbon dioxide. The other gases, if present, pass through the activated carbon essentially unchanged. The activated carbon functions to remove the ozone from the system. The O₂, carbon dioxide, and other gasses, if present, then are caused to pass, such as by a fan, suction pump, by convection or by any other suitable apparatus or means, into any suitable insect attracting and/or destroying trap or apparatus where the insect-attracting gaseous product is employed with any other physical and chemical attractants to attract the insects to an entrapment device.

Blood seeking insects, particularly mosquitoes, have carbon dioxide receptors around the base of their antennae. Normally, about 100 ml/min carbon dioxide, which binds to the insects' receptors, is required to elicit host-seeking behavior in most species of biting flies, midges and mosquitoes. However, it has been discovered that the attractiveness of carbon dioxide is enhanced up to about 10-fold or more when provided by the process and apparatus of this invention. In the presence of the insect-attracting gaseous product of this invention, much larger collections of insect collections have been achieved with less carbon dioxide than with carbon dioxide alone as provided by other sources.

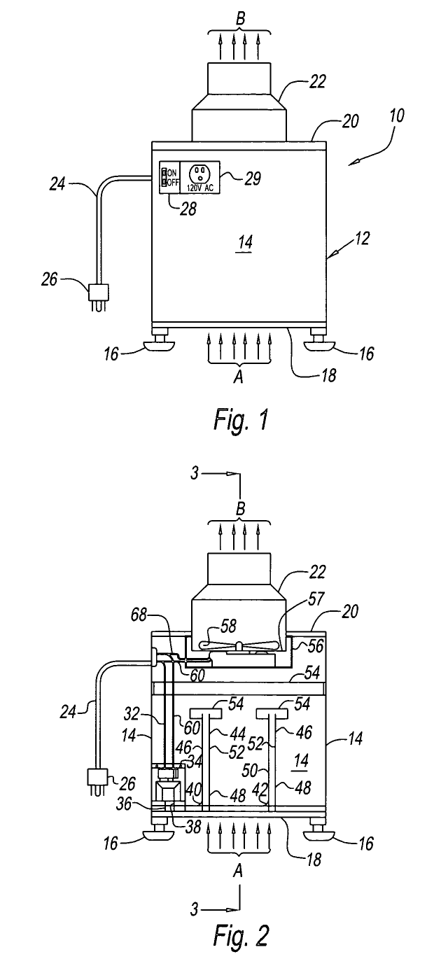

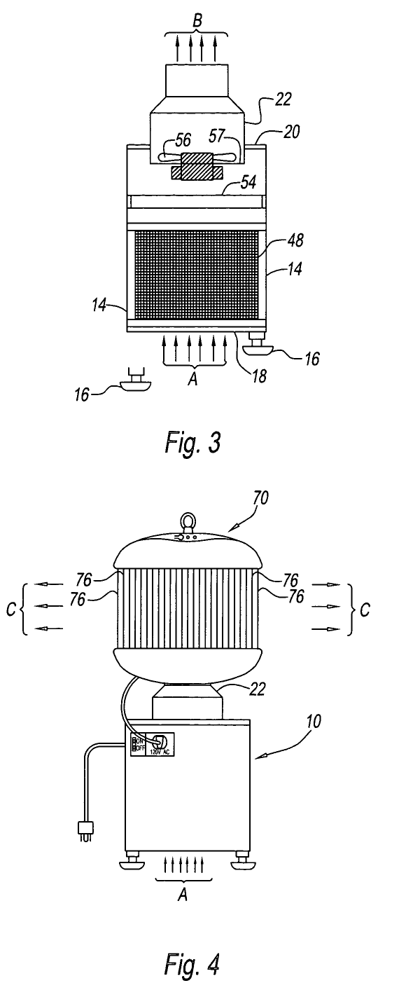

In FIGS. 1 to 3 there is shown an illustrative ozone generator equipped with an activated carbon source for providing an insect-attracting gaseous product in accordance with this invention for use with an insect entrapment device. The ozone generator can be any suitable device for generating ozone from air or pure oxygen, such as for example, UV light generators and corona discharge generators. In a UV light generator, a plasma tube, such as a mercury plasma tube, is used to generate UV light of wavelengths sufficient to dissociate diatomic oxygen in air into molecular oxygen that then combines with other diatomic oxygen in the air being drawn or forced into the generator to form ozone. Such an UV ozone generator is available from Prozone, Inc. of Huntsville, Ala. In a corona discharge ozone generator the ozone is generated by a surface discharge phenomenon between a high-voltage electrode and a low-voltage electrode, which phenomenon is used to ionize air being drawn or forced through the device and between the two electrodes. Such an ozone generator is available from Air-Zone Inc. of Hampton, Va. Among such suitable corona discharge ozone generators available from Air-Zone are their models Air-Zone XT400 and XT-800. FIGS. 1 to 3 illustrate the invention with a corona discharge ozone generator. Any suitable source of activated carbon, in any suitable shape or form, can be utilized in the process and apparatus of this invention. As an example of suitable activated carbon there may be mentioned an activated carbon mesh pane of the type use as filters, e.g., Honeywell, Inc.'s Activated Carbon Prefilter #38002.

In FIGS. 1 to 3 there is illustrated an ozone generator 10 modified to produce an output of an insect-attracting gaseous product according to the present invention. The ozone generator 10 comprises a housing 12 of any suitable shape, the shape being shown as rectangular in FIGS. 1 to 3. The housing 12 comprises four joined side panels 14. The housing 12 is provided with leg supports 16, preferably at or near the four corners of the housing, to provide a space for a flow of air, indicated by arrows A, to be drawn or forced into and through the housing. The housing 12 generally has an open-grated bottom panel or panel with vents 18 to permit flow of the air into the generator housing. The top of the housing 12 is provided with a cover panel 20 which has a vent or discharge element 22 projecting generally perpendicularly from the cover panel for providing means to discharge the gaseous products of the generator, as indicated by arrows B. The vent element is preferably a tapered conduit.

In the embodiment illustrated, the generator 10 is provided with an electrical lead 24 and plug 26 for connecting the device to a suitable outlet of an electrical power source (not shown). The device could, however, be powered by a battery unit as the electrical power source. An off/on switch 28 is provided on the housing 10 for activating or deactivating the electrical power source. The generator unit 10 can also be provided with plug receptacle 29 for providing electrical power for a purpose to be explained later. Electrical leads 30 and 32 are provided for connecting the electrical power to a transformer 34 in the housing 10. Transformer 34 outputs suitable voltage/current via electrical leads 36, 38, 40 and 42 to electrodes 44 and 46 located in the lower portion of the housing proximate the open-grated bottom panel 18. Each electrode comprises two metal screen grids 48 and 50, separated by a ceramic core 52 held together by an insulating cap 54. In housing 10, between the electrodes 44 and 46 and the vent 22, there is located an activated carbon element 54, such as a Honeywell, Inc. Activated Carbon Prefilter #38002, positioned so that air or oxygen that has been subjected to corona discharge from the electrodes 44 and 46 has to pass through the activated carbon element to reach the vent. A support element 56 attached to cover 20 supports a fan 58 located in the entrance 57 of vent 22. Fan 58 is electrically connected to the power source by electrical leads 60 and 62 and operates to draw air A into housing 10 through open grated bottom panel 18 and force gaseous products B out vent 22. If desired, the generator 10 could be provided with a remote control and means activated by the remote control for operating the unit, such as for example, to turn the unit off or on.

When electrical power is provided to the generator unit 10 and the unit is turned on via switch 28, fan 56 draws air A into the unit where the air passes through the corona discharge provided by electrode elements 44 and 46 and ozone, with other gasses, such as an oxide of nitrogen, is produced. In an embodiment wherein pure oxygen is utilized as the input gas instead of air A, the oxygen is drawn into the unit 10 where it passes through the corona discharge provided by electrode elements 44 and 46 and, in general, ozone alone is produced. The ozone is then forced by fan 56 to be drawn into contact with the activated carbon 54 where ozone is converted to diatomic oxygen and carbon dioxide. The other gasses, if present, pass through the activated carbon essentially unchanged. The activated carbon removes the ozone from the system. The diatomic oxygen, carbon dioxide, and other gasses, if present, are then forced by the fan 56 to exit the housing 10 through vent 22, thereby providing an insect-attracting gaseous product for use with an insect attracting and/or destroying device as illustrated in FIG. 4.

In FIG. 4, the generator unit 10, as depicted in FIGS. 1 to 3, has an insect attracting/destroying trap unit 70, (such as one of the type disclosed in U.S. Pat. No. 6,055,766, the disclosure of which is incorporated herein) mounted over vent 22 so as to receive the gaseous products B. If the insect trap 70 is of such a nature as to require or need electrical power it can be provided with an electrical lead 72 having a plug 74 for plugging into electrical outlet 29 on housing 10. For example, the trap 70 may have an electrical grid (not shown) inside the trap for destroying insects attracted to the trap and electrical lead 72 may be used to power that grid. The gases B from generator unit 10 are forced by fan 56 (FIGS. 1 to 3) to flow through vent 22 into trap 70 and out through vertical supports 76 of the trap as attractant gases identified by arrows C to act as attractants for insects.

It will be appreciated that, although the invention has been illustrated in FIG. 4 by use of a generator unit with an insect trap of the type described in U.S. Pat. No. 6,055,766, any ozone generator unit of this invention may be employed with any suitable or useful insect attracting and/or destroying device. That is, the trap unit may be of any suitable size or shape and may utilize any suitable other insect attractant and/or any suitable insect destroying means. For example, the trap may be one employing any one or more additional attractants, such as for example, heat, light such as near UV and UV light, insect audible sounds such as heartbeat mimicked sounds, natural and synthetic pheromones, and natural and synthetic kairomones. The trap may also employ one or more entrapment/destruction means, such as for example, sticky or adhesive material to trap and confine the insects, a vacuum source to collect the attracted insects, an electrical grid or the like to kill or destroy the attracted insects.

It has been discovered that the gaseous mixture of trace amounts of carbon dioxide with at least one oxide of nitrogen gases acts as an improved attractant compared to carbon dioxide alone. In fact, it has been discovered and demonstrated in tests that insect attractiveness can be increased 10-fold or more over carbon dioxide alone when the insect-attracting gaseous mixture from an activated carbon modified ozone generator, which gas contains at least one oxide of nitrogen and, at most, trace amounts of carbon dioxide, is employed as the attractant.

For example, three mosquito traps were tested in field trials lasting nine days in October of 2002. The test protocol was a 3 by 3 Latin Square in which three commercially available Dragonfly traps manufactured by BioSensory, Inc of Willimantic, Conn. were baited with different attractants. Trap Number 1 was baited with octenol and a pulsed discharge of 250 ml/min CO₂ from a canister, producing CO₂ concentrations of approximately 7000 parts per million at the discharge point. Trap Number 2 was baited with octenol alone. Trap Number 3 was baited with octenol and a preferred embodiment of the insect-attracting gaseous product of this invention in a continuous discharge, the insect-attracting gaseous product of these tests initially containing a CO₂—NOₓ mixture having CO₂ concentrations of approximately 750 parts per million at the discharge point, with the CO₂ concentration of the mixture falling to levels that were indistinguishable from ambient levels within one hour. Three test locations were established at mosquito-infested areas near Tweed Airport in West Haven Conn. Each trap was tested at each location overnight. Every day mosquito collections in each trap were removed, identified by species, counted and recorded. Traps were then rotated to the next test location and the test was repeated that night. In order to test each trap at each location, one complete rotation of the protocol required three nights. The test protocol was repeated three times over nine consecutive nights.

Data from this field trial appears in the Table below.

| Trap | | Mosquito Collection | |
|---|---|---|---|
| No. | Bait | Species | Total |
| 1 | Octenol, 250 ml/min CO₂ | 7 | 263 |
| 2 | Octenol | 4 | 28 |
| 3 | Octenol, insect-attracting gaseous | 8 | 118 |
| | product | | |

Although Trap Number 3 generated only one-tenth the amount of CO₂ compared to the emissions of Trap Number 1, and these amounts dropped to levels that were indistinguishable from ambient levels within one hour, its collections were equal to 44.8% of the collections of Trap Number 1 and were drawn from a larger number of mosquito species. Compared to Trap Number 2, which had no CO₂ emissions, Trap Number 3 collections were 420% larger and were drawn from twice as many mosquito species.

While the invention has been described herein with reference to the specific embodiments thereof, it will be appreciated that changes, modification and variations can be made without departing from the spirit and scope of the inventive concept disclosed herein. Accordingly, it is intended to embrace all such changes, modification and variations that fall with the spirit and scope of the appended claims.

We claim:

1. A process for supplying an insect-attracting gaseous product to an insect trap for attracting insects, the process comprising passing at least one of air and oxygen through an ozone producing unit to produce a gaseous product containing ozone, passing the gaseous product containing ozone through activated carbon to produce a insect-attracting gaseous product, and providing the insect-attracting gaseous product to the insect trap.

2. The process of claim 1, wherein the insect-attracting gaseous product contains at least carbon dioxide.

3. A process according to claim 1 wherein ozone producing unit comprises an element for producing a corona discharge area for contacting at least the air or oxygen to produce the gaseous product containing ozone.

4. A process according to claim 1 wherein the insect trap to which the insect-attracting gaseous product is provided also contains at least one further insect attractant and elements for retaining and optionally destroying insects attracted to the trap.

5. Apparatus for providing an insect-attracting gaseous product to an insect trap comprising:
an enclosed housing having an inlet for entry of at least one of air and oxygen into the housing and a discharge outlet for discharge of an insect-attracting gaseous product, said discharge outlet adapted to be placed in fluid communication with an insect trap for providing the insect-attracting gaseous product to said trap;
an element in said housing for treating at least one of air and oxygen to produce a gaseous mixture containing ozone;
an activated carbon element;
a fluid pathway through said housing for providing flow of at least one of air and oxygen to the element for producing an ozone-containing gaseous product and thereafter for said ozone-containing gaseous product to contact the activated carbon element to produce an insect-attracting gaseous product, and then for said insect-attracting gaseous product to be discharged through the discharge outlet.

6. The apparatus of claim 5, wherein the insect-attracting gaseous product contains at least carbon dioxide.

7. The apparatus of claim 5 wherein the element for producing the ozone-containing gaseous product comprises at least one pair of electrodes in said housing and connectable to a source of electrical power for providing a corona discharge area in said housing.

8 A device for trapping and optionally destroying insects comprising:
an insect trap; and
an ozone-producing unit provided with activated carbon for producing an insect-attracting gaseous product by contacting the activated carbon with ozone produced by the unit, said unit being in fluid communication with said insect trap for providing the insect-attracting gaseous product to the insect trap.

9. A device according to claim 8, wherein the insect-attracting gaseous product contains at least carbon dioxide.

10. A device according to claim 8 wherein the ozone-producing unit comprises a corona discharge area.

11. A device according to claim 8 wherein the ozone-producing unit comprises:
an inlet for entry of at least one of air and oxygen into the unit;
a discharge outlet for discharge of the insect-attracting gaseous product from the unit to the insect trap; and
a fan for causing entry of at lease one of air and oxygen into the unit through the inlet and discharge of the insect-attracting gaseous product through the discharge outlet.

12. A device according to claim 10 wherein the ozone-producing unit comprises:
an inlet for entry of at least one of air and oxygen into the unit;
a discharge outlet for discharge of the insect-attracting gaseous product from the unit to the insect trap; and
a fan for causing entry of at least one of air and oxygen into the unit through the inlet and discharge of the insect-attracting gaseous product through the discharge outlet.

13. A process for attracting and optionally destroying insects comprising providing to an insect trap an insect-attracting gaseous product produced by the process of claim 1.

14. A process for attracting and optionally destroying insects comprising providing to an insect trap an insect-attracting gaseous product produced by the process of claim 2.

15. A process for attracting and optionally destroying insects comprising providing to an insect trap an insect-attracting gaseous product produced by the process of claim 3.

16. A process for attracting and optionally destroying insects comprising providing to an insect trap an insect-attracting gaseous product produced by the process of claim 4.

17. A process for attracting and optionally destroying insects comprising providing an insect trap of claim 8 in an area suspected to be inhabited by the insects and operating the device to produce the insect-attracting gaseous product.

18. A process for attracting and optionally destroying insects comprising providing an insect trap of claim 9 in an area suspected to be inhabited by the insects and operating the device to produce the insect-attracting gaseous product.

19. A process for attracting and optionally destroying insects comprising providing an insect trap of claim 10 in an area suspected to inhabited by the insects and operating the device to produce the insect-attracting gaseous product.

20. A process for attracting and optionally destroying insects comprising providing an insect trap of claim 11 in an area suspected to be inhabited by the insects and operating the device to produce the insect-attracting gaseous product.

21. A process for attracting and optionally destroying insects comprising providing an insect trap of claim 12 in an area suspected to be inhabited by the insects and operating the device to produce the insect-attracting gaseous product.
